(19) United States
(12) Patent Application Publication
(10) Pub. No.: US 2009/0258610 A1
(43) Pub. Date: Oct. 15, 2009

(54) APPARATUS FOR MULTIPLE MODULATIONS WITH A TRANSITION MODE IN A BASEBAND TRANSMITTER AND METHOD THEREFOR

(75) Inventors: Chia-Wei Kuo, Taipei City (TW); Shih-Chun Peng, Taipei City (TW); Chun-Hung Liu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/103,040

(22) Filed: Apr. 15, 2008

(51) Int. Cl. H04B 1/02

(52) U.S. Cl. 455/102

(57) ABSTRACT

An apparatus for multiple modulations with a transition mode in a baseband transmitter and method therefor. An apparatus includes a first modulator, a second modulator, and a modulation output device. The first modulator performs a first modulation to produce a first modulated signal. The second modulator performs a second modulation to produce a second modulated signal. In response to a mode selection signal indicating switching the desired modulation output signal from a current one of the first and the second modulated signals to another one thereof, the modulation output device operates in a transition mode for a transition period to generate the desired modulation output signal according to a weighted sum of the first modulated signal and the second modulated signal. After the transition period, the modulation output device outputs the another one as the desired modulation output signal.

### BACKGROUND OF THE INVENTION

1. Field of the Invention

The invention relates in general to multiple modulations in a communications system, and more particularly to an apparatus for modulation mode switch in a baseband transmitter and a method therefor.

2. Description of the Related Art

Different modulation mode switch is inevitable for a transmitter with multiple modulations for operating in multiple wireless communication environments. One example is a mobile phone compliant with operation modes including Global System for Mobile communications (GSM), Enhanced Data GSM Environment (EDGE), and General Packet Radio Service (GPRS). In a baseband transmitter of such a mobile phone, the major feature is Gaussian minimum shift keying (GMSK) modulation scheme for GSM and 8-level phase-shift keying (8PSK) modulation for EDGE. If the mobile phone needs to operate to provide higher data rates in transmitting multimedia data, for example, the modulation mode of the baseband transmitter is switched from GMSK to 8PSK modulation. Failure to make a smooth transition frome one modulation scheme to another one would degrade the transmitter's performance, which can be judged by determining the “transient spectrum” and “power versus time (PvT) mask” with respect to the interslot timing between the two different modulation schemes.

A typical modulation mode switch technique is a direct switch method, which uses a multiplexer to directly switch between two different modulation schemes, 8PSK and GMSK, for example. However, intrinsic difference between these two modulation schemes makes the smooth transition difficult, thus degrading the transient spectrum performance dramatically.

To be compliant with given communications standards, for example, GSM and EDGE recommendations, the transmitter's output power, for example, indicated in FIG. 1, is required to fall within a power versus time (PvT) mask defined in GSM and EDGE recommendations by European Telecommunications Standards Institute (ETSI). Referring to FIG. 1, when required to switch the modulation mode, a transmitter is correspondingly controlled to output power during a period from time T₁ to T₂₁ that is, an interslot, to meet a specified requirement, such as a specified PvT mask. By the direct switch method, a modulation output signal switching directly from the GMSK mode to the 8PSK mode, for example, occurs in the middle of the period, resulting in a sharp drop in signal level for a transient moment. Hence, the transmitter's output power indicated in FIG. 1 has a corresponding sharp drop in power in the middle of the period. This sharp drop causes margins in a corresponding transient spectrum (not shown) with respect to frequencies to be not sufficiently wide, especially at 400 kHz, degrading the performance of the transient spectrum.

Thus, it is desirable that a technique for modulation mode switching overcomes the direct switch method's failure to make a smooth transition from one modulation scheme to another.

### SUMMARY OF THE INVENTION

It is therefore an object of the invention to provide an apparatus for multiple modulations with a transition mode in a baseband transmitter and method therefor to switch from a first modulation scheme to a second one by generating a modulation output signal based on a first modulated signal according to the first modulation scheme and a second modulated signal according to the second modulation scheme for a period of time, or called a transition period. The generation of the modulation output signal during the transition period can be designed to avoid abrupt changes in signal level of the modulation output signal.

The invention achieves the above-identified object by providing an apparatus for multiple modulations in a baseband transmitter. The apparatus includes a first modulator, a second modulator, and a modulation output device. The first modulator is used for performing a first modulation to produce a first modulated signal. The second modulator is used for performing a second modulation to produce a second modulated signal. The modulation output device receives the first modulated signal and the second modulated signal to output a desired modulation output signal in response to a mode selection signal. In response to the mode selection signal indicating switching the desired modulation output signal from a current one of the first and the second modulated signals to another one thereof, the modulation output device operates in a transition mode for a transition period to generate the desired modulation output signal according to a weighted sum of the first modulated signal and the second modulated signal. After the transition period, the modulation output device outputs the another one as the desired modulation output signal.

The invention achieves the above-identified object by providing a method for multiple modulations to generate a desired modulation output signal to be transmitted in a baseband transmitter. The method includes the following steps. A first modulated signal is provided according to a first modulation. A second modulated signal is provided according to a second modulation. The desired modulation output signal is generated in response to the first modulated signal, the second modulated signal, and a mode selection signal, and this step includes the following steps: in response to the mode selection signal indicating switching the desired modulation output signal from a current one of the first and the second modulated signals to another one thereof, producing the desired modulation output signal in a transition mode for a transition period according to a weighted sum of the first modulated signal and the second modulated signal; and after the transition period, outputting the another one as the desired modulation output signal.

The invention achieves the above-identified object by providing an apparatus for signal transmission with multiple modulations. The apparatus includes a detecting unit, a multiple modulation device, a multiple modulation device. The detecting unit is used for detecting a wireless signal received from a channel, wherein the detecting unit outputs a mode selection signal according to the wireless signal. The multiple modulation device, in response to the mode selection signal, for outputting a desired modulation output signal. In a first mode, the multiple modulation device generates a first modulated signal according to a first modulation as the desired modulation output signal. In a second mode, the multiple modulation device generates a second modulated signal according to a second modulation as the desired modulation output signal. In response to the mode selection signal indicating switching the desired modulation output signal from a current one of the first and the second modulated signals to another one thereof, the multiple modulation device operates in a transition mode to generate the desired modulation output signal according to a weighted sum of the first modulated signal and the second modulated signal for a transition period. After the transition period, the multiple modulation device outputs the another one as the desired modulation output signal. The channel coupling unit is used for coupling the desired modulation output signal to the channel for signal transmission.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a power versus time diagram illustrating a transmitter's output power when modulation mode switches from a GMSK mode to a 8PSK mode.

FIG. 2 is a block diagram illustrating an embodiment of a sub-system of a mobile station including a multiple modulation device to perform modulation mode switch according to the invention.

FIG. 3A is a block diagram illustrating a multiple modulation device in FIG. 2 according to an embodiment of the invention in terms of in-phase and quadrature components.

FIG. 3B illustrates an example of implementation of a signal output device illustrated in FIG. 3A.

FIGS. 4A-4E illustrate an example of modulation mode switching from 8PSK to GMSK modulation using a special combination of modulation outputs.

FIGS. 5A-5E illustrate an example of modulation mode switching from GMSK to 8PSK modulation using a special combination of modulation outputs.

### DETAILED DESCRIPTION OF THE INVENTION

In accordance with the invention, an approach to modulation mode switching is provided to switch from a first modulation scheme to a second one by generating a modulation output signal based on a first modulated signal according to the first modulation scheme and a second modulated signal according to the second modulation scheme for a period of time, or called a transition period. The generation of the modulation output signal during the transition period can be designed to avoid abrupt changes in signal level of the modulation output signal. After the transition period, the modulation output signal is switched to the second modulated signal. In one embodiment, a device providing multiple modulations operates in a transition mode for the transition period to generate the modulation output signal based on a weighted sum of the first modulated signal and the second modulated signal, wherein the first modulated signal has an increasing weighting with time and the second modulated signal has a decreasing weighting with time, for example. Based on the embodiment, a “multi-step mode transition” is provided with increasing and decreasing weightings varying in multi-step manner. In another embodiment, a special combination of modulation outputs is provided to make the modulation output signal generated by the multiple modulation device have a smoother transition. In addition, mode switch performance concerning transient spectrum can be further optimized by adjusting the timing with respect to the beginning of the transition period as well as the timing with respect to transmitter power control. The following will illustrate these embodiments in detail.

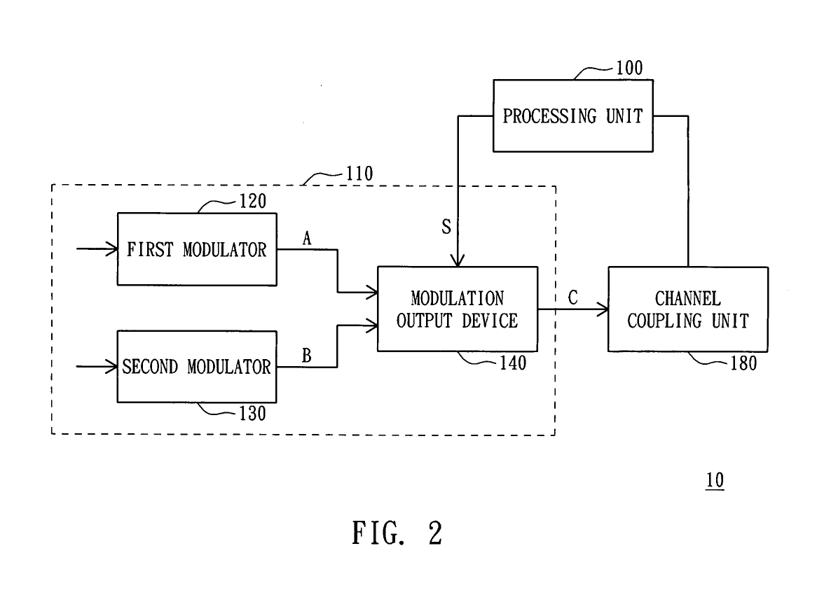

Referring to FIG. 2, a sub-system 10 for a mobile station with multiple modulations is shown according to an embodiment of the invention. The mobile station includes a sub-system 10 for signal transmission including a processing unit 100, a multiple modulation device 110, and a channel coupling unit 180. The processing unit 100, such as a microprocessor, is used for controlling the processing unit 100 to provide communication services in a multiple wireless communication environment, where communication services under different specifications are provided, for example, GSM and EDGE. The processing unit 100 can be used as a detecting unit for detecting a wireless signal received from a channel, such as a wireless signal indicating time-division multiplexing access (TDMA) data slots. According to the wireless signal received, the processing unit 100 determines the current status of the received signal and can determine the timing for modulation mode switching, if necessary. When the processing unit 100 determines that the sub-system 10 needs to be operate at an operating mode compliant with either GSM or EDGE, the processing unit 100 controls the sub-system 10 to operate at that mode. In such case, the processing unit 100 outputs a mode selection signal, denoted by S in FIG. 2, to indicate whether to perform modulation mode switching with respect to the current status of the received signal. The processing unit 100, on the other hand, can control the channel coupling unit 180, such as a radio frequency (RF) unit, which is used for coupling a modulation output signal generated by the multiple modulation device 110 to a channel, to compliant with RF power specification with respect to the modulation mode switching. The RF unit, for example, includes circuits, such as a filter, oscillator, RF power amplifiers, coupler, and antenna, for processing the modulation output signal from the multiple modulation device 110 to couple the processed modulation output signal to a wireless channel.

The multiple modulation device 110 is a device for providing a modulation output signal, denoted by C, according to multiple modulations. In one embodiment, the multiple modulation device 110, in response to the mode selection signal S, operates in at least a first mode, a second mode, or a transition mode, selectively, and generates a modulation output signal in a different way for each of the modes. In the first mode, the multiple modulation device 110 generates a first modulated signal according to a first modulation as the modulation output signal. In the second mode, the multiple modulation device 110 generates a second modulated signal according to a second modulation as the modulation output signal. In the transition mode, the modulation output signal is generated based on the first modulated signal and the second modulated signal for a period of time, or called a transition period, to switch the modulation output signal from a first modulation scheme to a second one so as to avoid abrupt changes in signal level of the modulation output signal during the transition period.

Specifically, the multiple modulation device 110 includes a first modulator 120, a second modulator 130, and a modulation output device 140, for example. The first modulator 120 and second modulator 130 receives input data, such as voice, data, or control signals to be transmitted. The first modulator 120 is used for performing the first modulation on the input data to produce the first modulated signal A. The second modulator 130 is employed to perform a second modulation on the input data to produce a second modulated signal B. For example, the first modulation is a GMSK modulation scheme defined in GSM standards while the second modulation is an 8PSK modulation scheme defined in EDGE standards. The modulation output device 140 is used for receiving the first modulated signal A and the second modulated signal B to output the modulation output signal C in response to the mode selection signal S. In one embodiment, in response to the mode selection signal S indicating switching between the first mode and the second mode, the multiple modulation device 110 operates in the transition mode to produce the modulation output signal C according to a weighted sum of the first modulated signal A and the second modulated signal B for the transition period. After the transition period, the modulation output device 140 outputs the another one as the modulation output signal to be desired.

In order to enable the modulation output signal to make a smooth transition from a current one of the first and second modulated signals to another one of the two signals, the current one has a decreasing weighting with respect to time and the another one has an increasing weighting with respect to time in one embodiment. The increasing weighting can be implemented in various ways, for example, an increasing function with respect to time, such as a linearly increasing value or an exponentially increasing value, or a predetermined sequence of increasing numbers, such as 0, 1, 3, 6, 7, 13, and so on. The decreasing weighting can also be implemented in various ways, such as a decreasing function with respect to time or a predetermined sequence of decreasing numbers.

In one embodiment that will also be used in the following for the sake of illustration, the increasing weighting is a value varying incrementally with respect to time t, denoted by IWₜ, and the decreasing weighting is a value varying decrementally with respect to time t, denoted by DWₜ. The modulation output signal, denoted by Cₜ, during the transition period can then be generated according to the expression:

Cₜ=DWₜ×M1ₜ+IWₜ×M2ₜ (equation 1),

where M1ₜ indicates the current one of the two modulated signals A and B, and M2ₜ indicates the another one of the two modulated signals A and B. As an example, the transition period can be divided into n pieces of time, such as 16 or 32, IWₜ can be designed as t/n, and DWₜ can be designed as (n−t)/n, where t indicates a time in the transient period, and t=0, 1, 2, 3, . . . , n, and the number n determines the resolution of the generation of the desired modulation output signal during the transition period. The implementation of the equation 1 with the weightings varying in this way can be designated as a “multi-step mode transition”.

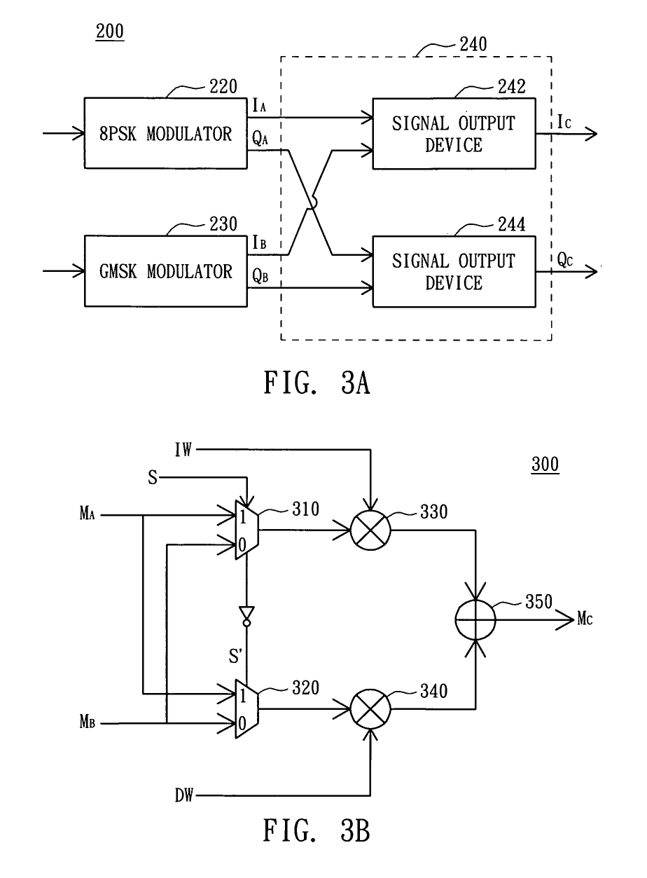

Referring to FIG. 3A, a multiple modulation device 200 is illustrated according to an embodiment of the invention in terms of in-phase and quadrature components. The multiple modulation device 200 is provided as an example of the multiple modulation device 110 indicated in FIG. 2. The multiple modulation device 200 includes an 8PSK modulator 220, a GMSK modulator 230, and a modulation output device 240. The 8PSK modulator 220 receives input data to generate a first modulated signal A according to an 8PSK modulation, for example, defined in EDGE recommendations. The first modulated signal A is a baseband digital complex signal including an in-phase (hereafter, I) signal and a quadrature (hereinafter, Q) signal of the first modulated signal A, denoted by I_{A} and Q_{A} respectively. The GMSK modulator 230 receives input data to generate a second modulated signal B according to a GMSK modulation, for example, defined in GSM recommendations. The second modulated signal B is a baseband digital complex signal including an I signal and a Q signal of the second modulated signal B, denoted by I_{B} and Q_{B} respectively. The modulation output device 240 receives the first modulated signal A and second modulated signal B to generate a modulation output signal C, which is a baseband digital complex signal including an I signal and a Q signal of the modulation output signal C, denoted by I_{C} and Q_{C} respectively. The modulation output device 240 further includes a first signal output device 242 and a second signal output device 244 to determine the signals I_{C} and Q_{C} respectively. The first signal output device 242 receives the signal I_{A} from the 8PSK modulator 220 and the signal I_{B} from the GMSK modulator 230 so as to generate the signal I_{C} of the modulation output device 240. The second signal output device 244 receives the signal Q_{A} from the 8PSK modulator 220 and the signal Q_{B} from the GMSK modulator 230 so as to generate the signal Q_{C} of the modulation output device 240.

In one embodiment, the multiple modulation device 200, in response to the mode selection signal S, operates in at least an 8PSK mode, a GMSK mode, or a transition mode, selectively, and generates the modulation output signal in a different way for each of the modes. In the 8PSK mode where an 8PSK modulated signal is desired, the signal output device 242 outputs the signal I_{A} as the signal I_{C} while the second signal output device 244 outputs the signal Q_{A} as the signal Q_{C}. In the GMSK mode where a GMSK modulated signal is desired, the first signal output device 242 outputs the signal I_{B} as the signal I_{C} while the second signal output device 244 outputs the signal Q_{A} as the signal Q_{C}. In the transition mode, the first signal output device 242 generates the signal I_{C} based on the signals I_{A} and I_{B}, and the second signal output device 244 generates the signal Q_{C} based on the signals Q_{A} and Q_{B}, for a period of time, or called a transition period, to switch the modulation output signal I_{C} from a current one of the 8PSK and GMSK modulated signals to another one of the two modulated signals so as to avoid abrupt changes in signal level of the modulation output signal I_{C} during the transition period.

FIG. 3B illustrates an example of a signal output device indicated in FIG. 3A. The first signal output device 242 and second signal output device 244 can be implemented using the circuitry of a signal output device 300 shown in FIG. 3B. Those skilled in the art would recognize that in addition to the circuitry in FIG. 3B, other equivalent circuitry or one with at least one or more equivalent circuit elements can be used to perform the modulation output signal C according to the invention. The signal output device 300 includes a selector 310, a selector 320, a multiplier 330, a multiplier 340, and an adder 350. The selector 310, such as a multiplexer, receives a signal M_{A} and a signal M_{B} and outputs one of the signals M_{A} and M_{B} as its output signal selectively according to a mode selection signal S. The selector 320 receives a signal M_{A} and a signal M_{B} and outputs one of the signals M_{A} and M_{B} as its output signal selectively according to a mode selection signal S′, which can be obtained for example by way of an inverter to invert the mode selection signal S.

In the transition mode, when the mode selection signal S, for example, having a value of 0, indicates switching the signal M_{C} from the signal M_{A} to the signal M_{B}, the selector 310 outputs the signal M_{B} and the selector 320 outputs the signal M_{A}, where the signal M_{A} is regarded as the current one of the signals M_{A} and M_{B} before the transition, and the signal M_{B} is the desired signal after the transition. The circuit shown in FIG. 3B can thus be employed to implement the previous embodiment with the equation 1 of Cₜ=DWₜ×M1ₜ+IWₜ×M2ₜ such that M_{C}=DWₜ×M_{A}+IWₜ×M_{B}, where Cₜ=M_{C}, M1ₜ=M_{A}, and M2ₜ=M_{B}. With respect to in-phase signals, the first signal output device 242 in FIG. 3A can be implemented using the circuit in FIG. 3B to generate the signal I_{C} according to the signals I_{A} and I_{B} such that the equation holds: I_{C}=DWₜ×I_{A}+IWₜ×I_{B}, where M_{C}=I_{C}, M_{A}=I_{A}, and M_{B}=I_{B}. As to quadrature signals, the second signal output device 244 in FIG. 3A can be implemented by using the circuit in FIG. 3B to generate the signal Q_{C} according to the signals Q_{A} and Q_{B} such that the equation holds: Q_{C}=DWₜ×Q_{A}+IWₜ×Q_{B}, where M_{C}=Q_{C}, M_{A}=Q_{A}, and M_{B}=Q_{B}.

Conversely, when the mode selection signal S, for example, having a value of 1, indicates switching the signal M_{C} from the signal M_{B} to the signal M_{A}, the selector 310 outputs the signal M_{A} and the selector 320 outputs the signal M_{B}, where the signal M_{B} is regarded as the current one of the signals M_{A} and M_{B} before the transition, and the signal M_{A} is the desired signal after the transition. In this case, the previous embodiment with the equation 1 can be implemented by using the circuit shown in FIG. 3B such that M_{C}=DWₜ×M_{B}+IWₜ×M_{A}, where Cₜ=M_{C}, M1ₜ=M_{B}, and M2ₜ=M_{A}. With respect to in-phase signals, the first signal output device 242 in FIG. 3A generates the signal I_{C} according to the signals I_{A} and I_{B} such that the equation holds: I_{C}=DWₜ×I_{B}+IWₜ×I_{A}, where M_{C}=I_{C}, M_{A}=I_{A}, and M_{B}=I_{B}. As to quadrature signals, the second signal output device 244 generates the signal Q_{C} according to the signals Q_{A} and Q_{B} such that the equation holds: Q_{C}=DWₜ×Q_{A}+IWₜ×Q_{B}, where M_{C}=Q_{C}, M_{A}=Q_{A}, and M_{B}=Q_{B}.

As previously illustrated in one example, during the transient period, the decreasing weighting DWₜ can be designed as (n−t)/n, and the increasing weighting IWₜ can be designed as t/n if the transition period is divided into n pieces of time, where t indicates a time in the transient period, and t=0, 1, 2, 3, . . . , n. If n is 32, the values of the decreasing weighting DWₜ are 1, 31/32, 30/32, . . . , 1/32, 0 sequentially and those of the increasing weighting IWₜ are 0, 1/32, 2/32, . . . , 31/32, 1 sequentially, where t=0, 1, 2, . . . , 32. After the transition mode the weightings IWₜ=IW₃₂=1 and DWₜ=DW₃₂=0, the equation 1 becomes Cₜ=DWₜ×M1ₜ+IWₜ×M2ₜ=M2ₜ. That is, the modulation output signal C is switched from the current one of the modulated signals, M1ₜ, to the another one, M2ₜ.

In the first signal output device 242 implemented using the signal output device 300, the output data of the selector 310 at the time t and the IWₜ at the time t are applied to the multiplier 330, while the output data of the selector 320 at the time t and the DWₜ at the time t are applied to the multiplier 340. After that, the adder 350 receives the results of the multiplier 330 and multiplier 340 to generate the signal I_{C}. The second signal output device 244 implemented using the signal output device 300 operates in a similar way to generate the signal Q_{C} according to the signals Q_{A} and Q_{B}. Those skilled in the art would recognize that the decreasing and increasing weightings can be implemented in various ways, including establishing a lookup table in a memory (not shown) to store the values of weightings, which can then be read, if needed, from the memory and fed into the multiplier 330 and multiplier 340 for calculation of the signal M_{C}. In addition, the multiplier 330 and multiplier 340 can be implemented using divider circuits.

During the transition period, different frequency sine-tones may be the outputs from the 8PSK modulator 220 and GMSK modulator 230. If the opposite phase of two frequency sine-tone (i.e. maximum value in one sine-tone and minimum value from another sine-tone) appears in the transition period, the waveform derived from the weighted sum of the outputs from the 8PSK modulator 220 and GMSK modulator 230 may be not smooth enough. In order to provide a smoother result, special combinations of outputs from two different modulators such as the 8PSK modulator 220 and GMSK modulator 230 are provided in one embodiment. In this embodiment, a smoother transition can be made according to a weighted sum of outputs from the 8PSK modulator 220 and GMSK modulator 230 during modulation mode switching by implementing one of the 8PSK modulator 220 and GMSK modulator 230 to provide a constant value, for example, null (zero) value, while keeping the other modulator to output a signal like a constant frequency sine-tone. If the special combination of modulators' outputs are taken in the equation 1 with weightings exemplified above, the waveform derived from the weighted sum will be either decreasing amplitude sine-tone or increasing amplitude sine-tone during the transition period, as illustrated in the following.

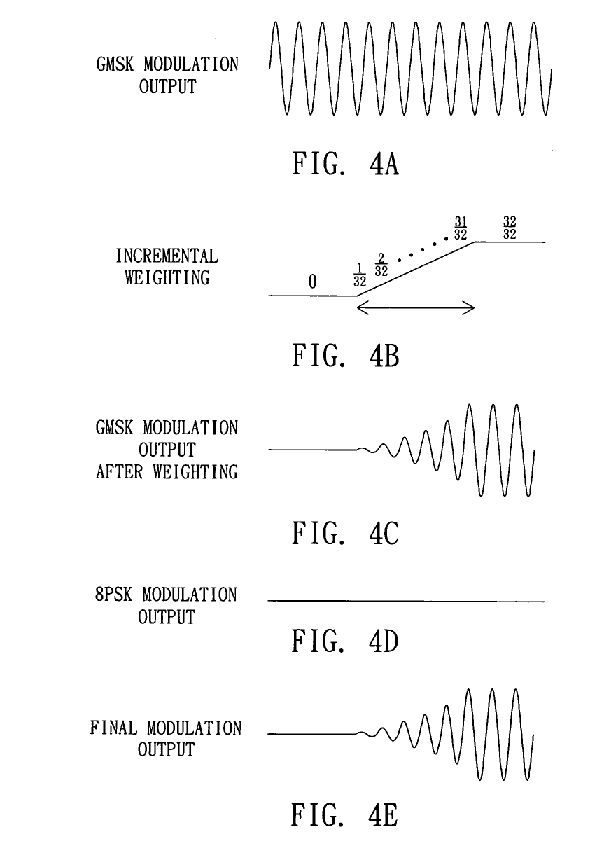

FIGS. 4A-4E illustrate an example of modulation mode switching from 8PSK to GMSK modulation using a special combination of modulation outputs. When modulation mode switching from 8PSK to GMSK modulation is desired, an 8PSK modulator, for example, the 8PSK modulator 220 in FIG. 3A, outputs a signal of constant value, for example, zero, as shown in FIG. 4D. Meanwhile, a GMSK modulator, for example, the GMSK modulator 230 in FIG. 3A, outputs a signal such as a sine-tone at a constant frequency of 67.7 kHz, for example, as shown in FIG. 4A. The values of the increasing weighting, such as the incremental weighting illustrated in FIG. 4B, are sequentially provided during the transition period, indicated by the arrow in FIG. 4B, for example, about two bit-times (about 7.38 μs). Since the desired modulation output signal is the GMSK modulation output, the GMSK modulation output is multiplied by the incremental weighting, resulting in a waveform illustrated in FIG. 4C. According to the equation 1, the waveforms shown in FIGS. 4C and 4D are combined to result in the weighted sum, that is, the desired modulation output signal. After the transition period, the desired modulation output signal is outputted according to the GMSK modulation output.

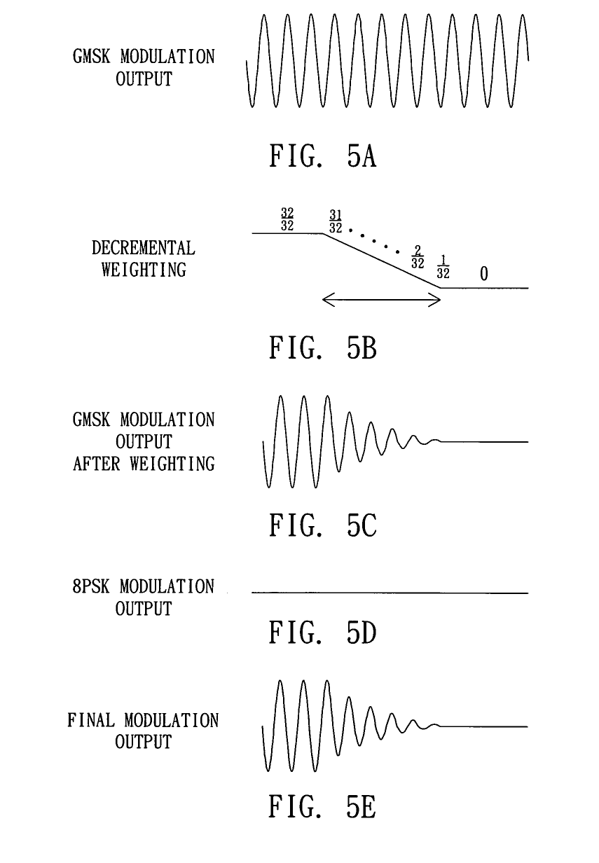

Referring to FIGS. 5A-5E, an example of modulation mode switching from GMSK to 8PSK modulation using a special combination of modulation is illustrated. In this case, when modulation mode switching from GMSK to 8PSK modulation is desired, a GMSK modulator, such as the GMSK modulator 230, outputs a signal such as a sine-tone at a constant frequency of 67.7kHz, for example, as shown in FIG. 5A. Meanwhile, an 8PSK modulator, such as the 8PSK modulator 220, outputs a signal of constant value, for example, zero, as shown in FIG. 5D. The values of the decremental weighting, such as the decremental weighting illustrated in FIG. 5B, are sequentially provided during the transition period, indicated by the arrow in FIG. 5B. Since the desired modulation output signal is the 8PSK modulation output, the GMSK modulation output is multiplied by the decremental weighting, resulting in a waveform illustrated in FIG. 5C. According to the equation 1, the waveforms shown in FIGS. 5C and 5D are combined to result in the weighted sum, that is, the desired modulation output signal. After the transition period, the desired modulation output signal is outputted according to the 8PSK modulation.

Mode switching performance with respect to implementation of “multi-steps mode transition” and “special combination of modulation outputs” is dramatically improved. With respect to the margin for transient spectrum, the margin at 400 khz is improved about 15 dB margin, for example, as compared to the conventional “direct switch method”. In addition, the power output of a transmitter implemented using “multi-steps mode transition” and “special combination of modulation outputs” can easily fall within the requirement of a PvT mask specified in the GSM standards.

Moreover, after implementing the “multi-steps mode transition” and “special combination of modulation outputs” to improve the performance for transient spectrum and PvT mask, one could further optimize the overall mode switching performance of a transmitter by considering another two factors. One factor is the timing control for modulation mode switch timing corresponding to the power amplifier control, and the another factor is the timing control for the modulation mode switch corresponding to the RF transmitter mode switch timing. If modulation mode switch timing and RF transmitter mode switch timing are optimally selected, the overall transient spectrum performance could be improved about 3dB. For the first factor, the modulator mode switch timing can be adjusted according to a “Power Amplifier (PA) control curve” which is used for controlling the PA for modulation mode switch, to improve the transmitter's performance during the modulation mode switch. That is, the transition period during which the desired modulation output signal is generated based on the first and second modulated signals can be made to start at a time within the period during which the PA is controlled according to the PA control curve. For example, the transition period can be made to start at a time where the power amplifier outputs minimum power. For the second factor, the time for the RF transmitter mode switch can be adjusted to ensure the RF transmitter under linear operation region.

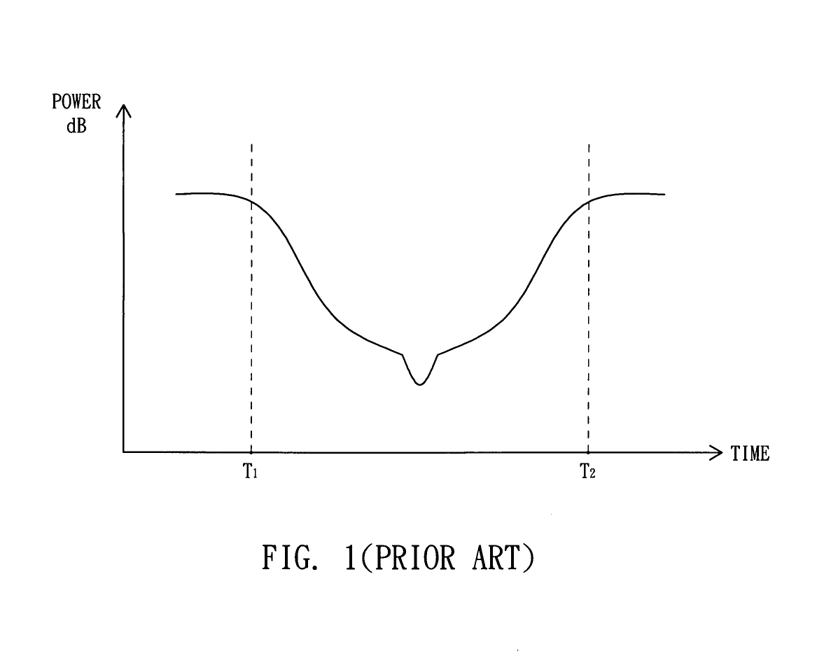

Referring to FIG. 1, the processing unit 100 can be used, or programmed, to adjust the timing of modulation mode switch. The processing unit 100 can be further used for determining when the multiple modulation device 110 begins to operate in the transition mode so as to improve transient spectrum performance of the transmitter during the transition period. The multiple modulation device 110 can be controlled to operate in the transition mode when the processing unit 100 controls the channel coupling unit 180 to operate according to a power amplifier control profile for a power control period, which is greater than the transition period. The processing unit 100 can be further used for determining when the channel coupling unit 180 operates in an operating mode corresponding to the desired modulation output signal so as to improve transient spectrum performance during the modulation mode switch. For example, the processing unit 100 can determine when to switch the channel coupling unit 180 to operate in an 8PSK mode corresponding to PA power control for 8PSK modulation, or in a GMSK mode corresponding to PA power control for GMSK modulation.

While the invention has been described by way of examples and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for multiple modulations in a baseband transmitter, the apparatus comprising:
a first modulator for outputting a first modulated signal according to a first modulation;
a second modulator for outputting a second modulated signal according to a second modulation; and
a modulation output device for receiving the first modulated signal and the second modulated signal to output a desired modulation output signal in response to a mode selection signal,
wherein in response to the mode selection signal indicating switching the desired modulation output signal from a current one of the first and the second modulated signals to another one thereof, the modulation output device operates in a transition mode for a transition period to generate the desired modulation output signal according to a weighted sum of the first modulated signal and the second modulated signal; after the transition period, the modulation output device outputs the another one as the desired modulation output signal.

2. The apparatus according to claim 1, wherein during the transition period, weighting of the current one is a decreasing function with respect to time.

3. The apparatus according to claim 2, wherein during the transition period, weighting of the another one is an increasing function with respect to time.

4. The apparatus according to claim 3, wherein during the transition period, the current one of the first and second modulated signals is outputted as a constant signal; and the another one of the first and second modulated signals is outputted as a signal indicating a sine-tone.

5. The apparatus according to claim 3, where during the transition period, the current one of the first and second modulated signals is outputted as a signal indicating a sine-tone; and the another one of the first and second modulated signals is outputted as a constant signal.

6. The apparatus according to claim 1, wherein the modulation output device operates in the transition mode to generate the desired modulation output signal according to the weighted sum of the first modulated signal and the second modulated signal with respective weightings varying with respect to time for the transition period to improve transient spectrum performance of the transmitter during the transition period.

7. The apparatus according to claim 1, wherein the first modulation is Gaussian minimum shift-keying (GMSK) modulation.

8. The apparatus according to claim 7, wherein the first modulation is eight-level phase-shift-keying (8PSK) modulation.

9. A method for multiple modulations to generate a desired modulation output signal to be transmitted in a baseband transmitter, the method comprising:
providing a first modulated signal according to a first modulation;
providing a second modulated signal according to a second modulation; and
generating the desired modulation output signal in response to the first modulated signal, the second modulated signal, and a mode selection signal, the generating step comprising:
in response to the mode selection signal indicating switching the desired modulation output signal from a current one of the first and the second modulated signals to another one thereof, producing the desired modulation output signal in a transition mode for a transition period according to a weighted sum of the first modulated signal and the second modulated signal; and
after the transition period, outputting the another one as the desired modulation output signal.

10. The method according to claim 9, wherein during the transition period, weighting of the current one is a decreasing function with respect to time.

11. The method according to claim 10, wherein during the transition period, weighting of the another one is an increasing function with respect to time.

12. The method according to claim 11, wherein during the transition period, the current one is provided as a constant signal, and the another one is provided as a signal indicating a sine-tone.

13. The method according to claim 11, where during the transition period, the current one is provided as a signal indicating a sine-tone, and the another one is provided as a constant signal.

14. The method according to claim 9, wherein the desired modulation output signal in the transition mode is generated according to the weighted sum of the first modulated signal and the second modulated signal with respective weightings varying with respect to time for the transition period to improve transient spectrum performance of the transmitter during the transition period.

15. The apparatus according to claim 9, wherein the first modulation is Gaussian minimum shift-keying (GMSK) modulation.

16. The apparatus according to claim 15, wherein the first modulation is eight-level phase-shift-keying (8PSK) modulation.

17. An apparatus for signal transmission with multiple modulations, comprising:
a detecting unit for detecting a wireless signal received from a channel, wherein the detecting unit outputs a mode selection signal according to the wireless signal;
a multiple modulation device, in response to the mode selection signal, for outputting a desired modulation output signal, wherein:
in a first mode, the multiple modulation device generates a first modulated signal according to a first modulation as the desired modulation output signal;
in a second mode, the multiple modulation device generates a second modulated signal according to a second modulation as the desired modulation output signal;
in response to the mode selection signal indicating switching the desired modulation output signal from a current one of the first and the second modulated signals to another one thereof, the multiple modulation device operates in a transition mode to generate the desired modulation output signal according to a weighted sum of the first modulated signal and the second modulated signal for a transition period; and
after the transition period, the multiple modulation device outputs the another one as the desired modulation output signal;
a channel coupling unit for coupling the desired modulation output signal to the channel for signal transmission.

18. The apparatus according to claim 17, wherein the multiple modulation device operates in the transition mode when the detecting unit controls the channel coupling unit to operate according to a power amplifier control profile for a power control period greater than the transition period.

19. The apparatus according to claim 18, wherein the detecting unit is further used for determining when the multiple modulation device begins to operate in the transition mode so as to improve transient spectrum performance of the signal transmission during the transition period.

20. The apparatus according to claim 19, wherein the modulation output device operates in the transition mode to generate the desired modulation output signal according to the weighted sum of the first modulated signal and the second modulated signal with respective weightings varying with respect to time for the transition period to improve transient spectrum performance of the signal transmission during the transition period.

21. The apparatus according to claim 18, wherein the detecting unit is further used for determining when the channel coupling unit operates in an operation mode corresponding to the desired modulation output signal so as to improve transient spectrum performance of the signal transmission during the transition period.

22. The apparatus according to claim 21, wherein the modulation output device operates in the transition mode to generate the desired modulation output signal according to the weighted sum of the first modulated signal and the second modulated signal with respective weightings varying with respect to time for the transition period to improve transient spectrum performance of the signal transmission during the transition period.

23. The apparatus according to claim 17, wherein the modulation output device operates in the transition mode to generate the desired modulation output signal according to the weighted sum of the first modulated signal and the second modulated signal with respective weightings varying with respect to time for the transition period to improve transient spectrum performance of the signal transmission during the transition period.

24. The apparatus according to claim 17, wherein the first modulation is Gaussian minimum shift-keying (GMSK) modulation.

25. The apparatus according to claim 24, wherein the second modulation is eight-level phase-shift-keying (8PSK) modulation.
